(19) United States
(12) Patent Application Publication
(10) Pub. No.: US 2006/0023443 A1
(43) Pub. Date: Feb. 2, 2006

(54) Flame emulating device

(76) Inventors: Alex Connelly, Garden Grove, CA (US); Ryan Eberle, Costa Mesa, CA (US); Bill Johns, Costa Mesa, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/182,627

(22) Filed: Jul. 15, 2005

Related U.S. Application Data
(60) Provisional application No. 60/588,100, filed on Jul. 15, 2004.

(51) Int. Cl. F21V 35/00

(52) U.S. Cl. 362/161

(57) ABSTRACT

The present invention is a wax candle simulation apparatus comprising one or more light emitting device(s), attached to a circuit which is commonly driven by, but not limited to, a micro-controller or passive components. The electronic circuit, in all forms is designed to control the amount of electricity that flows into the light-emitting device at any given time period. The electronic circuit can be, and is commonly, housed inside of a plastic enclosure which is adjustable by height so as to provide for varying sizes of the finished apparatus. The electronic circuit is adjustable by way of various switch configurations located on the underside of the plastic pod. These switch variations are commonly, but not limited to, a slide switch or slide switches and allow adjustment of the type and/or speed of the flicker. The entire pod, with electronics enclosed, is commonly inserted into an outer housing, which may be but is not exclusively made of scented or unscented wax with additives which improve the stability and longevity of the wax itself. The final apparatus can be placed in a multitude of applications and can commonly, but not exclusively, be used to replace any type of product that uses an actual flame to produce light.

This Application claims the benefit pursuant to 35 U.S.C. 119(e) of U.S. Provisional Patent Application Ser. No. 60/588,100, filed by the applicant on Jul. 15, 2004. Applicants also refer to their Design Pat. No. D488,582 issued Apr. 13, 2004 and incorporates it herein by reference.

### BACKGROUND OF THE INVENTION

Wax candles and candle lamps which use liquid fuel are traditionally used in multitudes of settings and applications. Open flames present a danger to both people and property. Open flame devices have inherent tendencies to extinguish in windy conditions or when it is raining. Open flame devices consume natural resources and expel dangerous toxins and particulates, which make them a concern for the health of any person within their vicinity. The present invention is designed to address all of these problems and provide solutions.

Conventional candles, and similar lighting devices with open flames for their light output, have a flame which “flickers”. The flicker in conventional candles typically appears to be random. In order to emulate the look of an open flame device, the present invention combines the pseudo-random flickering of a light-emitting device driven by electronic circuitry and encloses these components in a material which hides the components, yet allows the light output of the components to penetrate through the outside material.

The present invention may be powered be battery, or plugged into an A.C. power outlet with the addition of an AC to DC power supply. More than one candle may also be used together with a two-conductor wire allowing for multiple units driven by one low voltage power supply, approximately 3-14 volts or less. These multiple units can be commonly, but not exclusively, used in a fireplace instead of an actual fire, clustered in a chandelier to give a more realistic appearance, or as an outside arrangement on a patio or deck.

The electronic circuit, which includes a micro-controller or a solid state passive circuit, manipulates the amount of electrical current transmitted to the light-emitting device at any given time. The appearance of the invention can be changed in a multitude of ways by changing either the software code in the microcontroller, or changing the resistor values in the passive circuit. As a result of changing the resistor values (for example, a potentiometer may be used) or the software, the appearance of the flame of the candle will also change. The deviations in the software or the resistors represent a substitution in one or more of the values of the formula that governs the light emitting device, but does not require a change in the design or layout of the circuits. Both circuit designs allow for the use of a single on/off switch, or multiple switches. In the multiple switch configuration, the user can change the speed of the flicker and/or the type of the flicker providing a more realistic simulation, particularly when multiple units are grouped together and set at different flicker speeds and flicker types.

As the light-emitting device of the present invention is powered by electricity, it releases none of the toxins or particulates that are commonly associated with open flame devices. These toxins and particulates increase the risk of health problems and can be especially problematic for young people and people with lung or asthma conditions. Individuals who use oxygen to assist their breathing cannot be in the vicinity of an open flame due to the flammability of oxygen. The present invention allows these people to enjoy the appearance of candle light or a flame without the risks that an open flame would pose.

### BRIEF DESCRIPTION OF THE DRAWINGS

FIG. 1 of the drawings is a schematic circuit diagram that drives the light emitting device;

FIG. 2 of the drawings shows schematic circuit diagram which drives the light-emitting device in which the flicker rate can be modified;

FIG. 3 of the drawings is a schematic circuit diagram of another embodiment which drives the light-emitting device;

FIG. 4 of the drawings is a schematic diagram showing a circuit which drives the light emitting device in response to ambient light; and

FIG. 5 of the drawings is a listing the code for the microcontroller which is in the circuit shown in FIG. 3.

### SUMMARY OF THE INVENTION

The present invention is designed to replace wax candles, liquid fuel lighting containers as well as many other applications in which flames have been used. The present invention includes an apparatus comprising one or more light emitting devices, attached to a circuit which may be driven by either a microcontroller or passive components. An open flame emulator is disclosed which is powered electrically, and comprises an electronic circuit driving a light-emitting device in a pseudo-random manner. The components of the invention are housed in a material that will both hide the components and allow the light produced by the light-emitting device to be transmitted through the material providing a realistic emulation of a traditional open flame.

The electronic circuit of the present invention, in all of the embodiments, is designed to control the amount of electricity which flows into the light-emitting device at any given time period. The electronic circuit may be housed inside of a plastic enclosure or pod which may be inserted, for example, in the underside of a cylindrical candle. The pod is designed to be readily removable from the housing so that the consumer can change the circuits for driving the light emitting device such that the consumer can decide which features are desirable at any time. The entire pod with the circuits enclosed is inserted into an outer housing.

The electronic circuit is adjustable by way of various switch configurations also located on the underside of the housing. In a preferred embodiment of the invention, a slide switch or switches permits adjustment of the type and/or speed of the flicker.

The housing, in a preferred embodiment, is made with scented wax with additives which improve the stability and longevity of the wax itself. Other materials which provide a substitute for wax may also be used which include a self-skinning, expanding polyurethane foam which is almost identical in appearance to wax. An aromatic liquid or strip may also be added to provide a desired scent. The final apparatus can be placed in a multitude of applications and can be used to replace any type of product that uses, or can use, an actual flame to produce light.

### DETAILED DESCRIPTION OF THE PREFERRED EMBODIMENTS

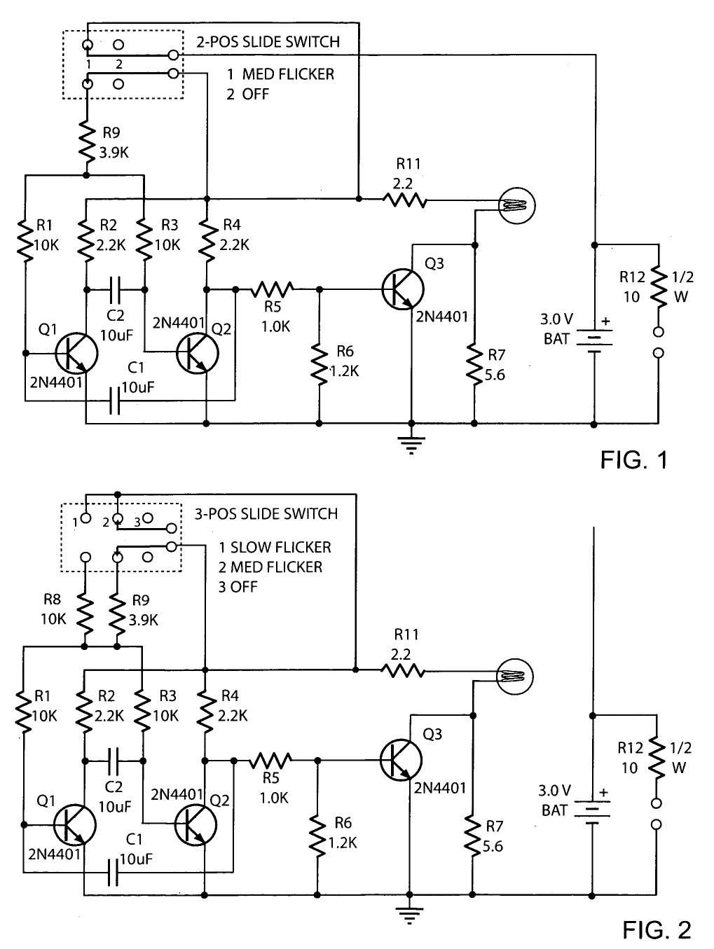

FIGS. 1-3 disclose circuits for controlling the light emitting device, L1. L1 may be, for example, a lamp, a light emitting diode, an incandescent bulb or other suitable electrical device which produces light.

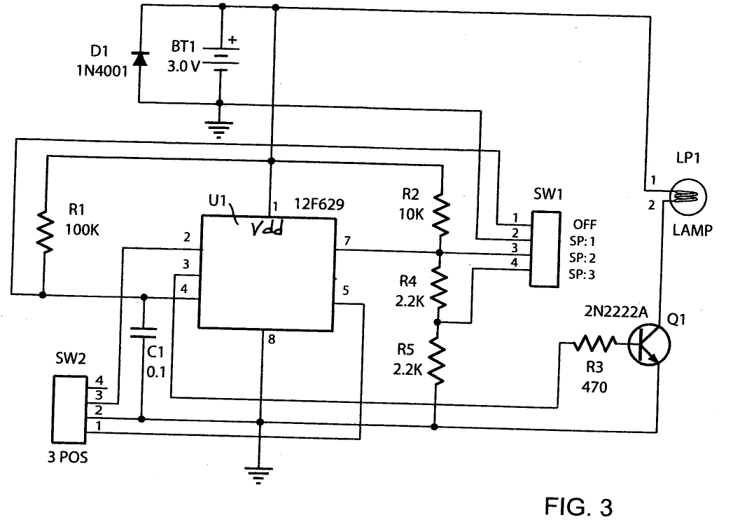

FIG. 1 discloses a first embodiment, a solid state circuit to control the light emitting device. In the circuit shown in FIG. 1, the speed and the type of flicker are not adjustable by the user, unlike the embodiments shown in FIG. 2 and FIG. 3, In the circuit disclosed in FIG. 1, the current flowing through the light emitting device, L1, is designed to be maintained between a maximum current level and a minimum or idling current level which may be approximately 10% of the maximum current.

The maximum current level in the circuit of the first embodiment shown in FIG. 1 can be adjusted by changing the resistor values of R7 and/or R11. In the preferred embodiment, as shown in FIG. 1, R7 is set at 5.6 ohms. In order to obtain a stronger, more apparent fluctuation from the light emitting device, the idling current is set to a lower level, to increase the difference between its maximum current (when transistor Q3 is on) and a minimum or idling current (when Q3 is off) is higher. Changing the value of Resistor R11, which can be a potentiometer, adjusts the amount of current to light-emitting device L1. The lamp current in the circuit shown in FIG. 1 is set at 180 mA when resistor R11 is 11 ohms. To simulate a flickering flame, the light should not go on and off abruptly, but should slowly become dimmer. In order to obtain a light fluctuation which appears as a flicker to the human eye, a modified sine wave is generated by the selection of the resistor values of R5 and R6 which sets the RC time constant. In the preferred embodiment, R5 and R6 are 1 K ohms and 1.2 K ohms, respectively.

The transistors Q1 and Q2 are arranged as a multi-vibrator circuit. When Q1 is on and Q2 is off, the base voltage of Q2 will increase gradually as the capacitor connected to the collector of Q1 begins to discharge through the resistor R4. When the base voltage of Q2 reaches approximately 0.6 volts, the base-to emitter voltage of Q2, Q2 changes state from on to off. When the base voltage of Q1 reaches approximately 0.6 volts, Q1 changes from off to on. The oscillation frequency determines the flicker frequency of the candle. The oscillation frequency of the multi-vibrator is set by the time constant, the values of the resistors and the capacitors.

The output of the multi-vibrator is a pulse or square wave form. However, in order to simulate the flicking candle flame, the pulse must be transformed to a modified sine wave or a type of triangle wave is required. The square wave is transformed into a a modified sine wave (hereinafter called the “RC wave”) using Capacitors C1 and C2 forming the RC circuit. The magnitude of the base current of Q3 is controlled by the selection of the resistor values of R5 and R6 which also sets the RC time constant and the frequency of the sine wave. Thus, when Q2 is off, Q3 effectively acts as a diode, such that all of the current will flow from output of capacitor C2, in the form of the RC wave, through the lamp slowly changing the brightness of the lamp making the light flicker. When Q1 is on, the idling current will follow from the collector of Q3 through the lamp L1 and will produce the minimum amount of brightness.

A switch on the housing may be used to apply power to the circuit in the on position, or cut off power in the off position as shown in FIG. 1. The circuit shown in FIG. 2 is similar to the circuit shown in the schematic of FIG. 1 in function and form, except that the slide switch illustrated in FIG. 2 has more than 2 positions. The additional positions are reserved to provide additional speeds of the flicker exhibited by the invention. The added positions are used in conjunction with resistor values R1 and R3, which are associated with resistor values R8 and R9, and combine to make the time constant value together with C1 and C2 which set the flicker frequency exhibited by the light-emitting device. When incorporated into the invention, the added positions allow the user to adjust the speed of the flicker.

FIG. 3 discloses a third embodiment which is a microcontroller-based circuit. The circuit may also use a microprocessor instead of a microcontroller. A microcontroller is selected a preferred embodiment because it is less expensive to design and manufacture than using a microprocessor. The embodiment shown in FIG. 3 is based on an 8-pin, single-chip microcontroller U1 with flash memory, such as the Microchip Technology PIC 12F629 device. It is a cost-effective, single-chip solution to the problem of providing a suitable waveform to control the light-emitting device. Other integrated circuits e.g. the PIC 10F629 chip may also be used. The PIC 12F629 has 1 K of Flash memory, 128 bytes of (Erasable Programmable Read Only Memory) EPROM, and a high current drive capability. The circuit of FIG. 3 produces square waves or pulses and powers the lamp by: (1) generating an idling current level similar to the circuit shown in FIGS. 1 and 2 and (2) generating the flicker using pulse-width modulation techniques.

The entire circuit is connected directly to the battery source of DC power and can also be run from a standard AC outlet with an AC to DC power supply having a regulated output of approximately 2-5 volts DC. Diode D1 provides reverse battery protection in the event that the user inadvertently inserts the batteries backwards. Light-emitting device LP1, in this circuit, an incandescent bulb, is driven by transistor Q1. Transistor Q1 boosts the current capability of the microcontroller output from 0.02 amps to over 0.5 amps.

A pulse-width modulator may be created either with hardware or using software. Utilization of a microcontrollers, such as the one described above, implements a pulse-width modulator (PWM) using a timer interrupt. Using an internal 4.0 MHZ oscillator, the basic timer period of the clock is 100 microseconds, implemented on a hardware interrupt basis. The PWM period is selected to be 100 times the timer period (10,000 microseconds or 10 milliseconds) so that decimal numbers may be entered for the corresponding bulb amplitudes. The PWM modulation is implemented in software by looking up the time period of the “on” cycle from a table with pre-determined values, the table being selected by slide switch SW2. The number selected is a decimal number from. the look up table from 0 (off) to 100 (on for the entire time period) for the 10-millisecond period. The “off” period of the PWM is 10 milliseconds minus the on period. The ratio of on to off periods is the duty cycle of the PWM. With a 50% duty cycle, the PWM is ON for 50 milliseconds and off for 50 milliseconds, the net power delivered to the light emitting device is 50% of maximum. For a duty cycle of 10%, the PWM and light-emitting device are on for 10 milliseconds and off for 90 milliseconds. By varying the power delivered to the load on a repetitively timed basis, the light-emitting device can be made to flicker just as in an actual open flame device such as a candle, a fireplace or any pattern which the user finds attractive. The present invention is designed so that the consumer can experiment with different flicker frequencies, brightness patterns creating his own unique lighting sequences.

The mode and speed of operation is determined by two different slide switches, SW1 (4 positions, single pole) and SW2 (3 positions, single pole). However, it will be appreciated that many different types of control devices known in the art may be used to provide external control of the mode, speed and brightness of the light. In the preferred embodiment shown in FIG. 3, SW1 selects the “off” mode and 3 different speeds of the flicker pattern. In the “off” position, pin 4 of the microcontroller (the reset input) is connected to ground, thus holding the microcontroller in the “reset” mode. In the reset mode, the normal output pin 3 is disabled, thus the light emitting device is off and the microcontroller is halted from operating, putting it into a low current mode of current consumption (less than 1 microamp). Selecting the switch SW1 positions SP1, SP2, and SP3 activate the voltage divider formed by R2, R4, and R5. The input to pin 7 of U1 is a voltage comparator, the other side of which is internally controlled by an on-chip voltage reference activated by software. There are four modes of operation available with Switch SW1 as shown in FIG. 3: (1) selecting the SP1 position in Switch SW1 produces a voltage at pin 7 of approximately 0 volts (ground); (2) selecting SP2 position shorts resistor R4 giving a voltage of R5/(R5+R2) times Vdd, which equals about 0.92 volts with a 3 volt battery; (3) selecting the SP3 position causing all the pins of the switch to be open so that the voltage at pin 7 is (R4+R5) Vdd/R2+R4+R5 and (4) the off mode and position which pins 1 and 2 of the switch are shorted together.

When the switch SW2 is placed in the “Smooth Mode” to generate the slower flicker, an internal table of 256 different 8-bit values is selected. The magnitude of the steps or pulses do not change drastically from step to step giving the appearance of smooth transitions in light levels from higher to lower levels and back, such as an open flame device flickering in a room environment.

When switch SW2 is in the “Abrupt Mode”, an internal table of 256 different 8-bit values is selected which corresponds to PWM levels that occasionally make more drastic differences in intensity from step to step. The “Abrupt Mode” emulates an open flame device that is being used in the presence of a “breeze” or more turbulent ambient air situations. Hence, the abrupt mode causes the lamp to flickers more from higher light intensity levels to lower levels and back.

The speed settings are also derived from the timer interrupt of 10 ms and determine the number of changes in intensity per second. An internal software divider implemented from the basic timer interrupt determines this value as input from slide switch SW1. On the slowest setting, there are 10 updates per second so the table of 256 values is repeated every 25.6 seconds. On the medium setting, the update is about 15 times per second so that the table is repeated about every 17 seconds, and on the fastest setting, the update is about 22 times per second so that the table is repeated about every 11 seconds.

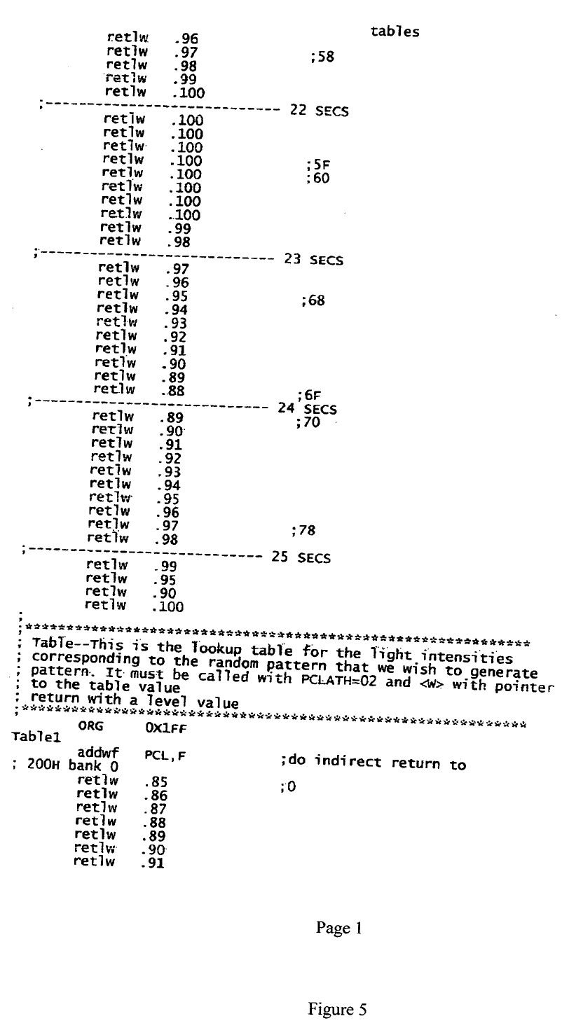

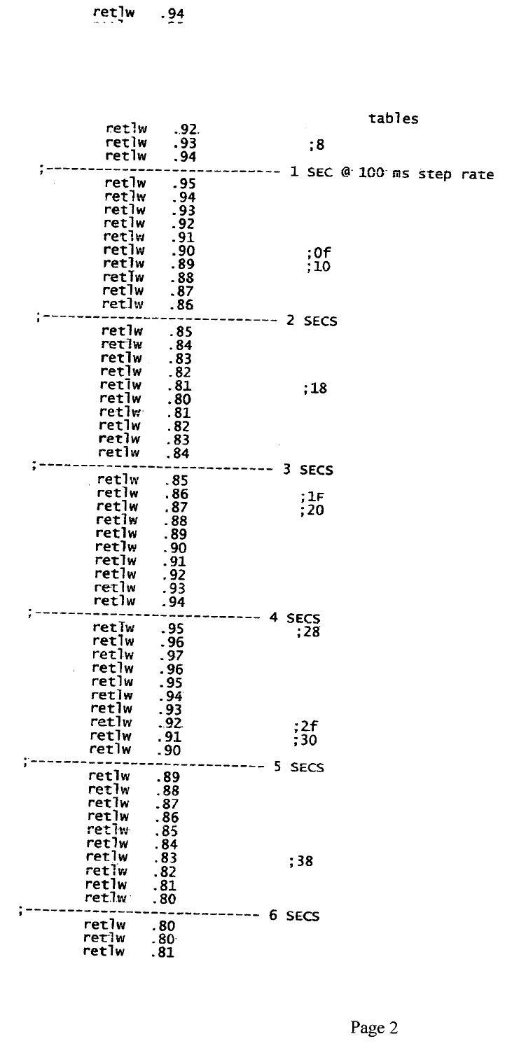

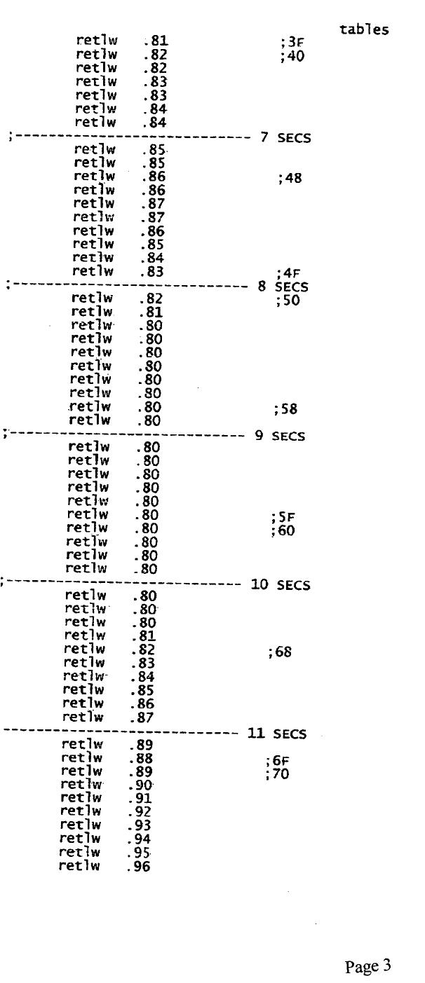

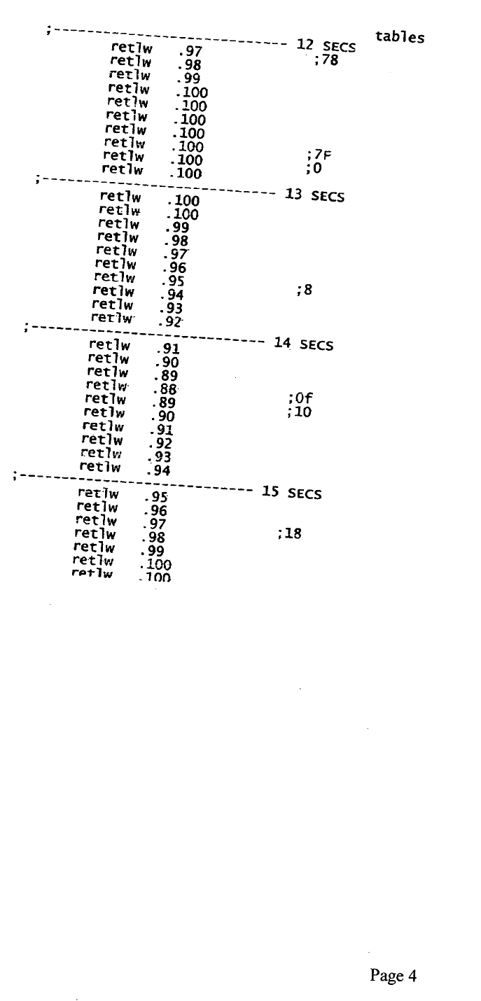

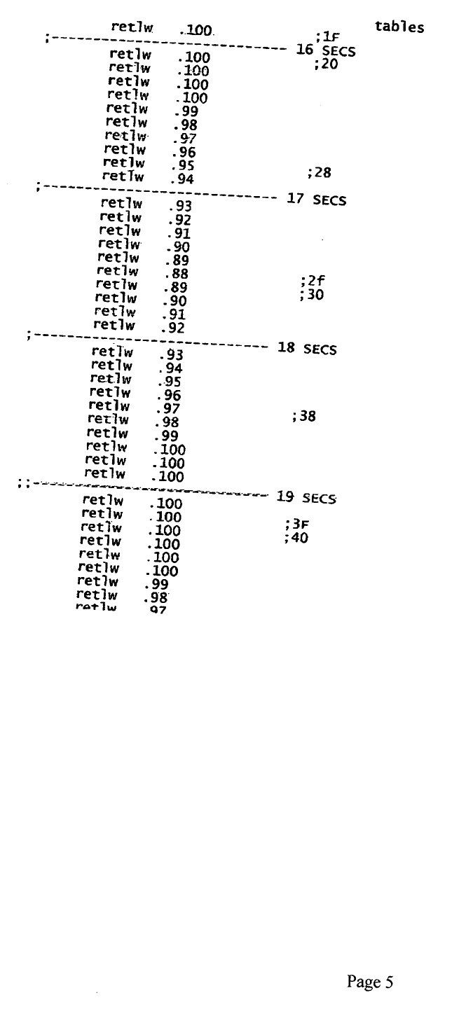

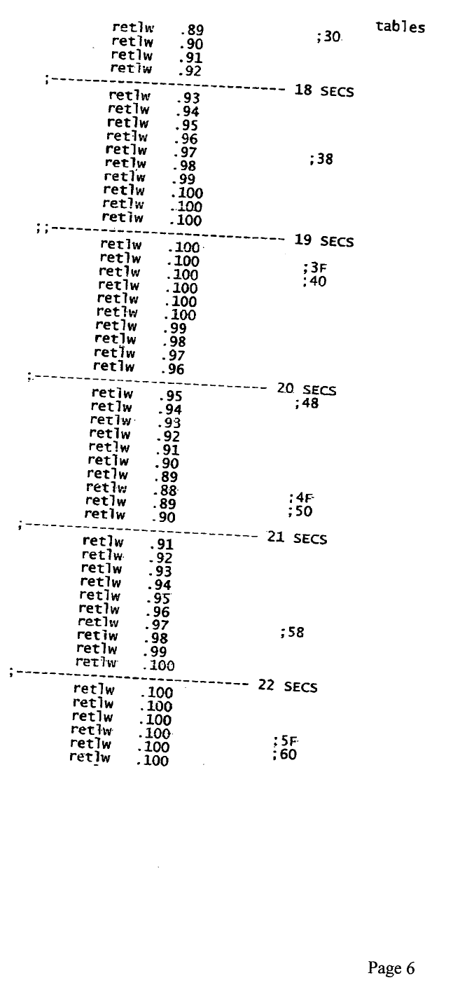

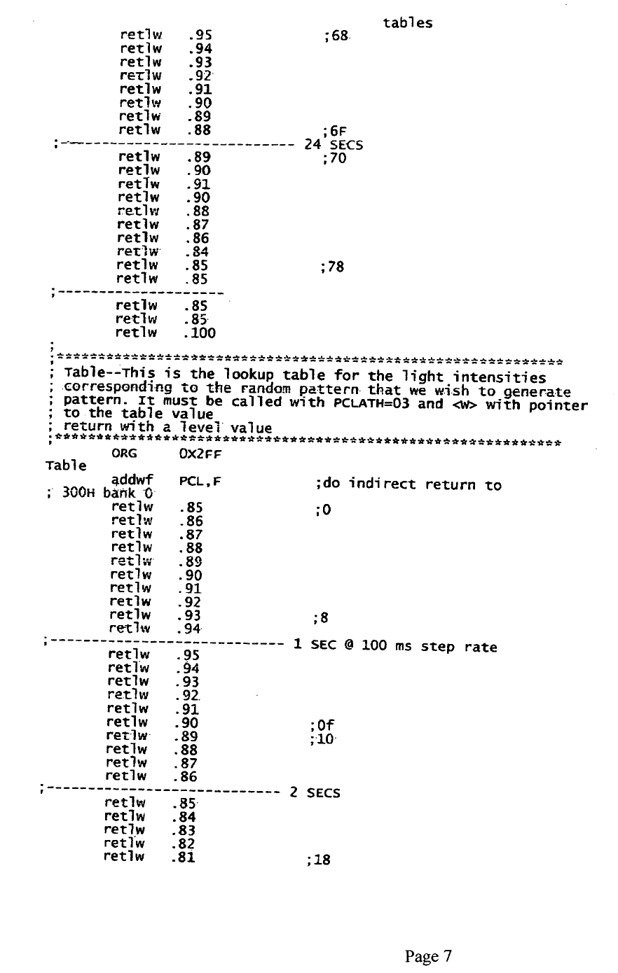

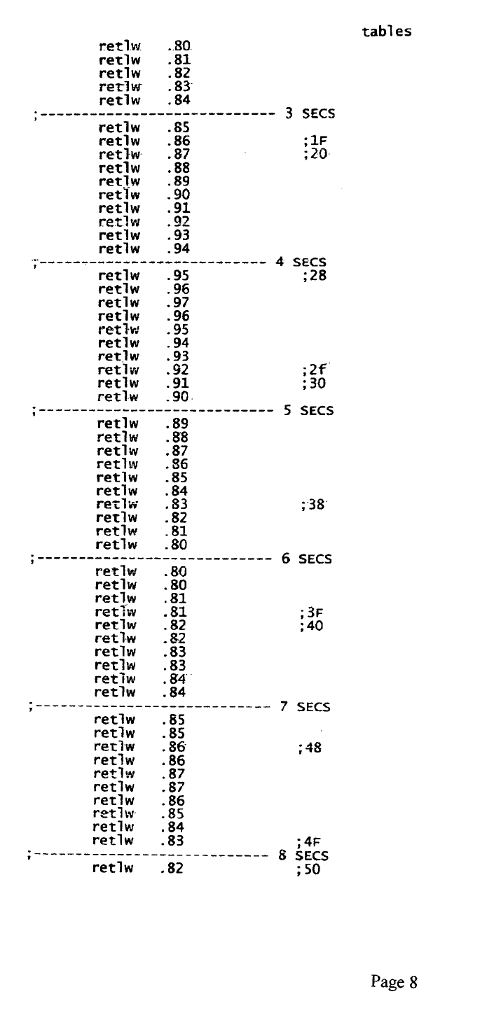

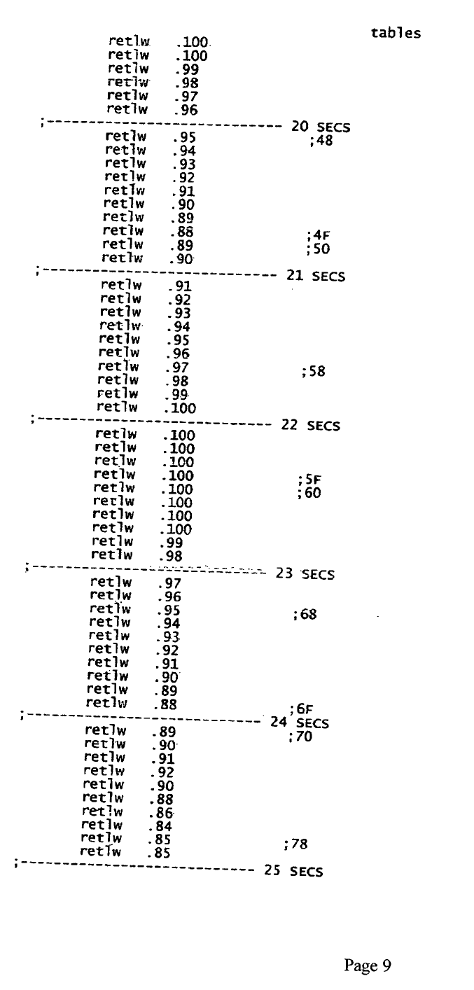

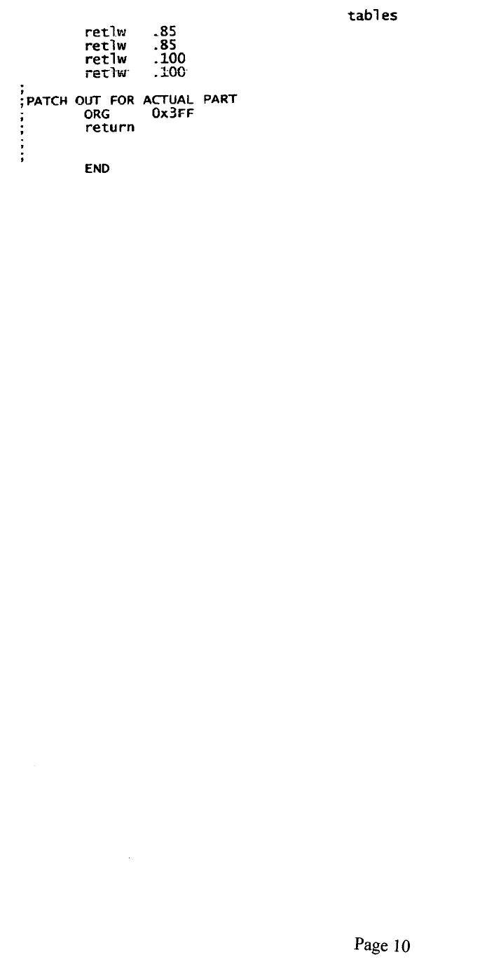

The mode switch SW2 operates by selectively grounding Pins 2, Pin 5, or neither. These logic levels are monitored and selected internally by the software code listed in FIG. 5. In the “Continuous On Mode”, Pin 2 and Pin 5 are a logic high, as determined by internal pull-up resistors. In the “Smooth” position of SW2, pin 2 is a logic low (Ground) and pin 5 is a logic high (+Vbat). In the “Continuous on Mode”, the Abrupt mode pin 5 is a logic low and pin 2 is a logic High.

When SW2 is in the “Continuous on Mode”, the light-emitting device is turned on at 100% power level (Constant on). There is no time-dependant modulation and the software pulse-width modulator is turned off. In the “Continuous on Mode”, the invention produces a non-varying light output with the software-created pulse width modulator turned off.

One of the preferred embodiments is a cylindrically-shaped wax housing, or simulated wax using self-skinned expanding polyurethane foam. This embodiment of the invention can be seen in Applicants' Design Pat. No. US D488,582 which is incorporated herein by reference.

It is desirable for the power supply to be at least one battery, in a preferred embodiment, so that when a wax candle is utilized, the power supply can be self-contained within the housing so that an AC power cord is not required. The batteries may be alkaline batteries or in another preferred embodiment, the batteries are rechargeable. When the electronic candles are use for “hospitality” purposes, such as at a restaurant table, with rechargeable batteries, the batteries can be removed each day, recharged, and returned to the candle. It substantially reduces restaurant owners' expenses to use rechargeable batteries rather than to replace them with new batteries. With prior art electronic candles, the batteries are not made to be replaceable, forcing the restaurant owners to purchase a new candle each time the batteries are no longer functional.

If scent, in addition to or in place of scented candle wax is desired, a removable scent strip may be added. Further, a reservoir of liquid scent can be added to the flame emulator apparatus which is activated upon application of heat generated by the electronic circuit.

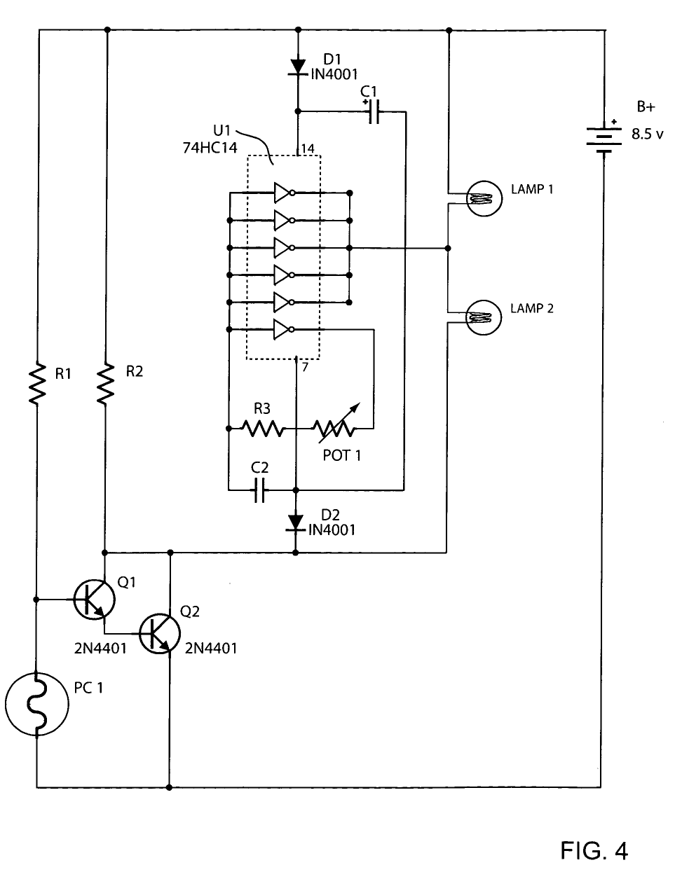

Another preferred embodiment includes a photo sensor so that the flame emulating device can be automatically activated in response to changes in ambient light. For example, a circuit is disclosed in FIG. 4 which includes a cadmium sulfide photo cell (PC1) which is activated when the ambient light becomes dark. When the photo cell PC1 is activated such that current flows through the transistors Q1 and Q2 and through a comparator circuit. An integrated circuit 74HC14 is configured so that when the voltage reaches a predetermined level, lamp 1 is activated and then lamp 2 is activated. Lamps 1 and 2 then flicker back forth such that lamp 1 is on and lamp 2 is off and then lamp 1 is off and lamp 2 is on. R1 may be adjusted to vary the circuit response to light sensitivity. Potentiometer 1 may be used to adjust the levels for the comparator circuit.

The circuit disclosed in FIG. 4 operates essentially as a flickering night light. However, it will be appreciated by those skilled in the art that other circuits may be utilized, for example, one lamp can be used instead two lamps, other photosensitive components can be used, and other voltage comparator circuits may be used.

The foregoing description of preferred embodiments is intended to be illustrative of possible devices which utilize the present invention and not intended to limit the scope of the present invention. It will be appreciated that there are various combinations using known components which are variations of the present invention as defined in the following claims.

1. A flame emulating device comprising:
a light emitting device;
a power supply in electrical connection with said light emitting device;
means for the user to vary the amount of current through said light emitting device from an idling level to a maximum level, said varying means in electrical connection with said light emitting device, whereby said current to said light emitting device flickers between said idling level and maximum level a predetermined number of times per second creating a flicker rate, thereby emulating a flickering flame and;
means for the user to change the values of said idling level and said maximum level of said current.

2. A flame emulating device of claim 1 further comprising means for altering said flicker rate.

3. The flame emulating device of claim 1 wherein said means for varying the current level is a multi-vibrator circuit.

4. The flame emulator device of claim 1 wherein said means for changing the values of said first level and said second level of said current is a potentiometer.

5. A flame emulating device comprising:
a light emitting device;
a power supply in electrical connection with said light emitting device;
a microcontroller programmed and adapted to vary the amount of current through said light emitting device from an idling level to a maximum level, said microcontroller in electrical connection with said light emitting device, whereby said current to said light emitting device flickers between said idling level and maximum level a predetermined number of times per second creating a flicker rate, thereby emulating a flickering flame and;
means for controlling the light emitting device wherein the user may vary the sequence of the flicker rates in conjunction with the values of said idling level and said maximum level of said current.

6. The flame emulator device of claim 1 wherein said power supply is at least one rechargeable battery.

7. The flame emulator device of claim 1 further including a reservoir for holding an aromatic liquid which is activating by heat generated by the power supply.

8. The flame emulator device of claim 1 further including a photo sensor control circuit adapted to selectively activate the device when the ambient light is less than a predetermined level.

9. A flame emulating device comprising:
a light emitting device;
a power supply in electrical connection with said light emitting device;
a microcontroller programmed and adapted to vary the amount of current through said light emitting device from an idling level to a maximum level, said microcontroller in electrical connection with said light emitting device, whereby said current to said light emitting device flickers between said idling level and maximum level a predetermined number of times per second creating a flicker rate, thereby emulating a flickering flame and;
means for controlling the light emitting device wherein the user may vary the sequence of the flicker rates in conjunction with the values of said idling level and said maximum level of said current.

10. A flame emulating device comprising
a light emitting device;
a housing through which said light emitting device can be viewed;
a power supply in electrical connection with said light emitting device;
means for the user to vary the amount of current through said light emitting device from an idling level to a maximum level, said varying means in electrical connection with said light emitting device, whereby said current to said light emitting device flickers between said idling level and maximum level a predetermined number of times per second creating a flicker rate, thereby emulating a flickering flame; and
means for the user to select the values of said idling level and said maximum level of said current wherein said varying means and said selection means are enclosed in a pod removably inserted into said housing.

11. The flame emulating device of claim 10 further including a photosensor control circuit adapted to selectively activating the light emitting device when the ambient light is less than a predetermined level.

12. The flame emulator device of claim 10 further including a reservoir for holding an aromatic liquid which is activating by heat generated by the power supply.

13. The flame emulator device of claim 10 wherein said housing is made of expanding polyurethane foam.
